(19) United States
(12) Patent Application Publication
(10) Pub. No.: US 2015/0239531 A1
(43) Pub. Date: Aug. 27, 2015

(54) SUPPORT FOR MOUNTING AND FOR THERMAL INSULATION OF LIQUID TANKS

(71) Applicant: Fraunhofer-Gesellschaft zur Foerderung der angewandten Forschung e.V., Muenchen (DE)

(72) Inventors: Kai Ehrich, Rostock (DE); Nikolai Glück, Rostock (DE); Linda Fröck, Rostock (DE); Arne Wilhelmsen, Rostock (DE)

(21) Appl. No.: 14/629,753

(22) Filed: Feb. 24, 2015

Related U.S. Application Data
(60) Provisional application No. 61/944,141, filed on Feb. 25, 2014.

(51) Int. Cl. B63B 25/08; B29C 45/00; F16M 13/00

(52) U.S. Cl. CPC B63B 25/08; F16M 13/00; B29C 45/0005; B29L 2031/3067

(57) ABSTRACT

A support for mounting and for thermal insulation of liquid tanks in ships with a support body which can be fixed to a structure of the ship and a method for the production of a support. The support body has a plastic material matrix for reducing the thermal conductivity, fillers which are embedded in the plastic material matrix for weight reduction and/or for reducing the thermal conductivity, and reinforcing fibres which are embedded in the plastic material matrix for increasing the pressure resistance.

### CROSS-REFERENCE TO RELATED APPLICATION

This application claims priority to Provisional Application No. 61/944,141, filed Feb. 25, 2014, which is herein incorporated by reference in its entirety.

### TECHNICAL FIELD

This application is related to the transport of gas, and more particularly, to the transport of liquefied gas.

### BACKGROUND

The transport of gas is increasingly effected in liquid gas tanks on ships, transport by waterways representing a flexible alternative to transport in pipelines. Transport in liquid tanks requires that the gas to be transported is firstly liquefied. The liquid tanks which are used differ basically accordingly to the type of liquefaction method used. Above all, liquefied petroleum gas (LPG) is thereby transported with use of a high pressure or a combination of pressure and low temperatures. Liquefied natural gas (LNG) is usually liquefied by use of very low temperatures down to −163° C. in order subsequently to be transported.

The liquid gas tanks are mounted in the ship structures by means of supports which are specially designed for this. The support thereby forms a critical point because of dual loading. The dual loading results from the task of load imposition of the liquid gas tank onto the ship structures and of the insulation requirement for the liquid gas tanks relative to the ship structure. In the case of a liquid gas tank, insulation is absolute necessary because of the very low temperatures of down to −163° C. which are required for liquefaction of the gases. The liquid gas tank in fact experiences a permanent heat introduction which leads to the liquefied gas evaporating above its boiling point. The heat introduction hereby takes place in particular in the region of the support.

The supports have been manufactured from synthetic resin compressed wood for a long time. However, the stresses on the supports made of synthetic resin compressed wood, due to the loads to be borne in combination with the movements of the ship and the permanent temperature differences, lead to problems with respect to icing, swelling and chipping on the support. For example, insulation of the synthetic resin compressed wood can be significantly diminished by introduction of moisture into the wood. As a result of lacking or greatly diminished insulation, an increased heat introduction into the liquid gas tank takes place, which is accompanied by evaporation of the liquid gas and hence involves a partial loss of load or great complexity with respect to energy recovery. In addition, as a result of the permanent low-temperature introduction from the liquid gas tank via the support into the ship structure, embrittlement of the ship structure can be effected.

### SUMMARY

In some embodiments, the disclosure describes a support for mounting and for thermal insulation of liquid gas tanks in ship structures which, during operation, has improved properties and high load-bearing resistance and also a high insulation effect.

In some embodiments, the disclosure describes a support for mounting and for thermal insulation of liquid tanks in ships with a support body which can be fixed to a structure of the ship. The support body has a plastic material matrix for reducing the thermal conductivity, fillers which are embedded in the plastic material matrix for weight reduction and/or for reducing the thermal conductivity, and reinforcing fibres which are embedded in the plastic material matrix for increasing the pressure resistance. Due to the combination of plastic material matrix, fillers and reinforcing fibres, the support has both good insulating properties and high pressure resistance. With the support according to the disclosure, a heat introduction into the liquid tank and also a low-temperature introduction into the ship structure can hence be reduced, with high pressure-resistance at the same time.

The reinforcing fibres which are embedded in the plastic material matrix can be orientated in at least one direction of a force exerted by the liquid tank on the support body. In some embodiments, the support body has a plurality of groups of reinforcing fibres which are orientated respectively in different directions. As a result, the pressure resistance can be further increased, in particular in the fibre direction. A temporally changing direction of a weight force of the liquid tank, during heavy swell or heeling over of the ship, can be compensated for by differently orientated reinforcing fibres.

In some embodiments, an angle between respectively differently orientated reinforcing fibres is less than, equal to or greater than 90°. For example, more than three angles of orientation can be provided. As a result, the reinforcing fibres can be orientated in fact in more than three directions. The reinforcing fibres can therefore be orientated in one, two, three or more directions. They can also form a network which is orientated in the corresponding directions.

The liquid tank can include different shapes and have for example a cuboid, spherical or cylindrical configuration. In some embodiments, the support body has a shape which corresponds to a shape of the liquid tank. The reinforcing fibres can be orientated, in this case, such that they extend parallel to a force component of the liquid tank acting on the support body. Hence they can also be orientated within the support body at varying angles of orientation. Also a location of the support can be important for orientation of the reinforcing fibres. Thus the reinforcing fibres are normally orientated differently, in the case of a support body disposed on the liquid tank at the side, from in the case of a support body disposed below the liquid tank.

The support can be designed both as a fixed and a floating support. For example, a support configured as a floating support can only bear vertical weight forces exerted by the liquid tank on the support body and enables displacement of the liquid tank in the longitudinal direction or transverse direction. In some embodiments, the reinforcing fibres are for this reason orientated in the vertical direction in the case of a floating support disposed below the liquid tank. A support configured as fixed support fixes the liquid tank both in the longitudinal direction and transverse direction and in the vertical direction. As a result, undesired displacements of the liquid tank in the ship can be reduced. In the case of a fixed support, it can therefore be advantageous that the reinforcing fibres are orientated in at least three directions (longitudinal direction, transverse direction, vertical direction).

The reinforcing fibres can be configured as essentially rigid bars which are covered preferably with plastic material. Whilst non-embedded reinforcing fibres without a covering can be flexible, non-embedded reinforcing fibres which are designed as rigid bars and covered with plastic material are normally rigid. The material of the plastic material covering can hereby differ from the material of the plastic material matrix, however it can also be provided that the same material is used.

In some embodiments, the pressure resistance of the support body in the direction of a force exerted by the liquid tank on the support body is at least 60 N/mm². A pressure resistance of this magnitude suffices in most cases for secure mounting of the liquid tank.

The fillers can have cavities and/or be mixed with gases. As a result, the weight of the support or of the support body can be reduced. The support body can have for example a specific weight (density) of at most 1.5 g/cm³. Furthermore, the fillers can be essentially spherical. The fillers can include for example hollow balls and/or glass granulates and/or foamed glass granulates. Also a mixture of the mentioned materials can be provided as filler. The fillers can have a diameter of at least 0.25 mm and/or a diameter of at most 5 mm. According to size, the fillers can have for example a density of 0.2 to 0.9 g/cm³. In some embodiments, the support body has a volume proportion of fillers of at least 5%. In some embodiments, the volume proportion of fillers is up to 35%.

A volume proportion of reinforcing fibres in the support body can be at least 10%. Furthermore, the support body can include a volume proportion of reinforcing fibres of up to 35%. The support body can hence have a volume proportion of fillers and of reinforcing fibres of in total at most 70%. An increase in the volume proportion of the reinforcing fibres can lead to an increase in pressure resistance and/or density, whilst an increase in the volume proportion of fillers is able to cause a reduction in the heat conductivity and/or the density of the support body. According to the composition of the support body, the pressure resistance and the heat conductivity respectively can vary as a function of each other and be adapted to optimum conditions.

In some embodiments, the support body has a thermal conductivity of at most 0.3 W/m*K or at most 0.25 W/m*K or at most 0.21 W/m*K. The thermal conductivity of the support body can be at least 0.10 W/m*K or at least 0.15 W/m*K or at least 0.20 W/m*K.

The reinforcing fibres can have a diameter of at least 0.25 mm and/or a diameter of at most 5 mm. It can also be provided that reinforcing fibres with respectively different diameters are embedded in the plastic material matrix. The reinforcing fibres can have, in addition, for example a length of 5 cm up to 100 cm or more. In some embodiments, the reinforcing fibres extend over a total height or length or width of the support body. Furthermore, the reinforcing fibres can form, within the plastic material matrix, e.g. bars, a grid, a mat, a fabric/laying, a multiaxial fabric, a roving woven material, rovings or a woven material.

Furthermore, the support body can have a linear heat expansion coefficient in a temperature range of −200° C. to 100° C. of at most 20*10⁻⁶ K⁻¹. In some embodiments, the linear heat expansion coefficient in the fibre direction is 12*10⁻⁶ K⁻¹ to 17*10⁻⁶ K⁻¹. Shrinkage or expansion of the liquid tank due to cooling or heating when filling or unloading the liquefied gas can consequently be borne readily and mechanical stresses in the liquid tank or in the adjacent ship structure are extensively reduced.

Furthermore, the support body can have a moisture absorption, at 20° C. and 65% relative air humidity, of less than 5%, and, in some embodiments, of less than 3%. As a result of resistance of the plastic materials used to moisture intake, swelling of the support can advantageously be reduced.

The reinforcing fibres include, e.g. aramide-, carbon-, basalt-, glass-, polyamide-, polyester- or natural fibres. The mentioned fibres have different properties. Thus aramide fibres have a relatively high moisture absorption but low heat conductivity, whilst carbon fibres display relatively high heat conductivity with low moisture absorption. Carbon- and aramide fibres can be used if relatively high pressure resistance is demanded. Glass fibres can have a relatively low heat conductivity. Also a mixture of different reinforcing fibres can be provided in the support body. A reduction in the thermal conductivity of the support body can be accompanied, for example, by a reduction in density and/or in pressure resistance. The properties of the support body can therefore be adapted, according to requirement, by the use of different reinforcing fibres.

The plastic material matrix can comprise, at least predominantly, epoxy resin, polyester resin, phenol resin, polyurethane resin or vinyl ester resin or at least consist of one of the mentioned resins. Here also, the person skilled in the art is able to distinguish between the properties of the mentioned resins. In some embodiments, the mentioned resins have relatively low heat conductivity. Whilst vinyl ester resin has good resistance to sea water, polyester resin is for example resistant to water without dissolved salt.

The above-mentioned reinforcing fibres, plastic material matrices and fillers and also the volume proportions thereof in the support body can be combined together to correspond to the prescribed mounting conditions. In particular, in some embodiments they can be combined together to determine an optimum combination of plastic material matrix, reinforcing fibres and fillers for a support of liquid tanks.

The disclosure also describes a method for the production of a support for mounting and for thermal insulation of liquid tanks in ships with a support body which can be fixed to a structure of the ship. The method comprises the following steps:
providing a mould,
disposing reinforcing fibres and fillers in the mould,
filing the mould with a liquid plastic material resin,
curing the plastic material resin to form a plastic material matrix and
removing the support body from the mould.

In some embodiments, filling the mould with the plastic material resin is effected by a vacuum-assisted resin transfer moulding method or by a vacuum injection method. It can be provided that the reinforcing fibres are saturated in a second plastic material resin before being disposed in the mould and, in a cured state of the second plastic material resin, are orientated in the mould in at least one direction.

The method is particularly well suited to the production of an above-described support.

While multiple embodiments are disclosed, still other embodiments will become apparent to those skilled in the art from the following detailed description, which shows and describes some embodiments. Accordingly, the drawings and detailed description are to be regarded as illustrative in nature and not restrictive.

### BRIEF DESCRIPTION OF THE DRAWINGS

Embodiments of the disclosure are explained with reference to the accompanying Figures.

FIG. 1 is a diagram illustrating a section through a support of a liquid gas tank, which is configured as a floating support, in a ship, according to some embodiments described in the disclosure,

FIG. 2 is a diagram illustrating a section through a support of a liquid gas tank, which is configured as a fixed support, in a ship, according to some embodiments described in the disclosure,

FIG. 3 is a diagram illustrating a section B through a support body from FIG. 2, according to some embodiments described in the disclosure,

FIG. 4 is a diagram illustrating a section A through a support body from FIG. 1, according to some embodiments described in the disclosure,

FIG. 5 is a diagram illustrating a section C through the support body from FIG. 1, according to some embodiments described in the disclosure, and

FIG. 6 is a diagram illustrating a section D through the support body from FIG. 2, according to some embodiments described in the disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

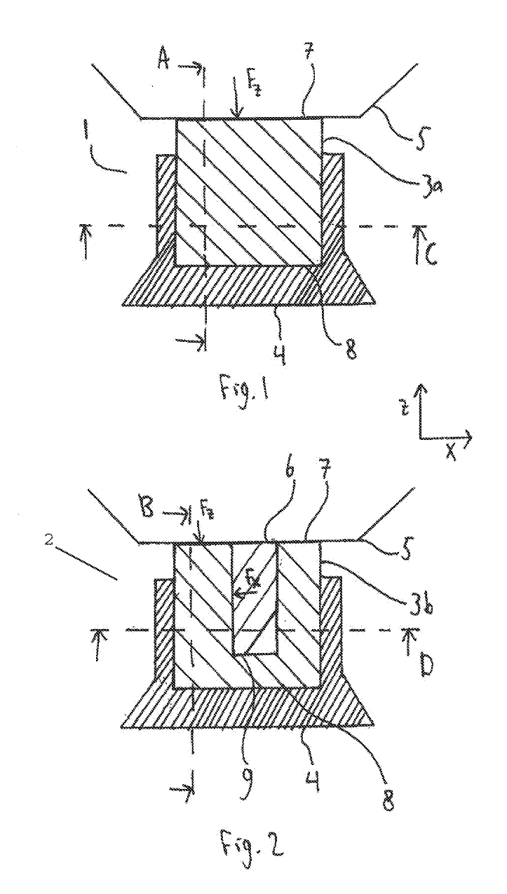

In the Figures, recurrent features are provided with the same reference numbers. Firstly, reference is made to FIGS. 1 and 2.

FIGS. 1 and 2 show a floating support 1 and a fixed support 2 for mounting and for thermal insulation of a liquid gas tank 5 in a ship. The support 1 and 2 has a support body 3a and 3b with an upper side 7 and also a lower side 8 which is fixed on a ship structure 4. The liquid gas tank 5 is a so-called LNG tank (Liquefied Natural Gas) and contains liquid methane which is cooled to a temperature of −163° C. It is insulated by insulation and has an essentially curved shape and can have for example a spherical, cylindrical or cuboid configuration, the spherical form normally representing an optimum constructional shape both for pressure and for insulation. In addition to methane, alternatively also other gases can be stored in the liquid gas tank. The liquid gas tank 5 can optionally also be an LPG tank (Liquefied Petroleum Gas). In some embodiments, the liquid gas tank is insulated by insulation known from the state of the art.

The floating support 1 absorbs weight forces of the liquid gas tank in the z direction and enables displacement of the liquid tank 5 in the horizontal direction of the support (the y direction into the page and/or the x direction), for example due to movements of the ship. In the case of a support 2 configured as a fixed support, the support body 3b has a groove 9 in which a strut 6 mounted on the liquid gas tank 5 is disposed. As a result, the liquid gas tank 5 is fixed both in the vertical direction z of the support and in the longitudinal direction x of the support. The fixed support 2 fixes the liquid gas tank 5 in addition in the transverse direction of the support (the y direction, not illustrated). In the case of the fixed support 2, undesired displacements of the liquid gas tank 5 in the ship can therefore be avoided. In the case of the floating support 1, the liquid gas tank 5 can, in contrast, shrink or expand as a result of cooling or heating during filling or unloading of the liquefied gas into the tank 5 or out of the tank 5. As a result, stresses in the liquid gas tank 5 and in the ship structure 4 can be avoided or reduced.

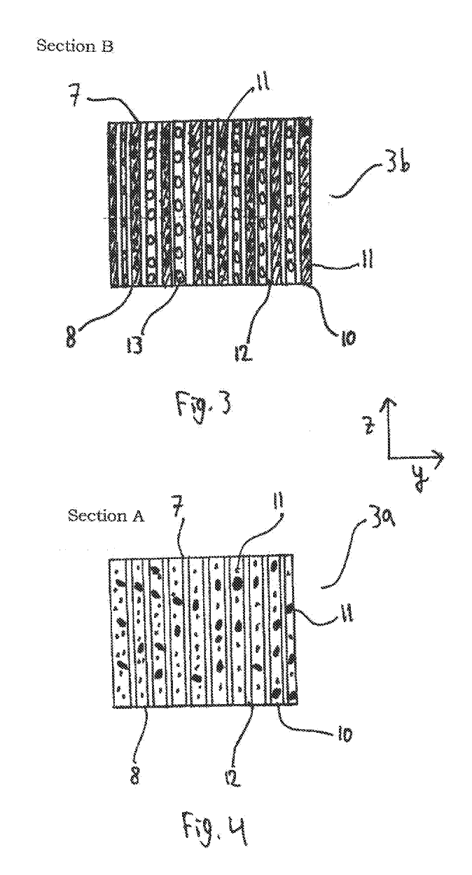

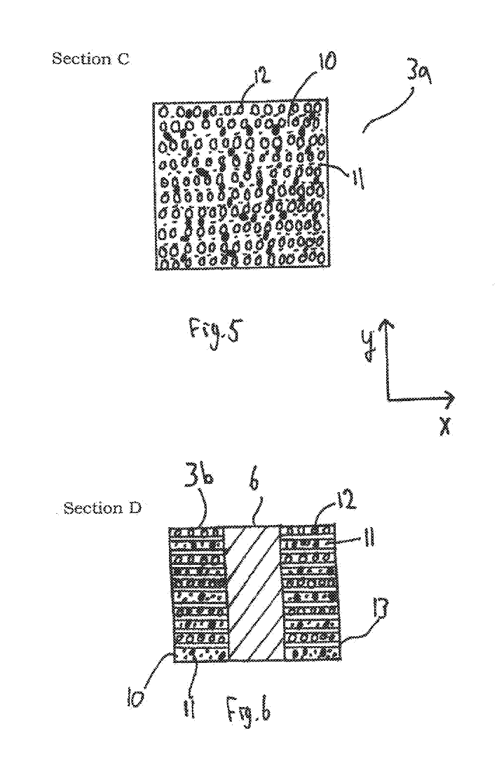

In the following, reference is made in addition to FIGS. 3 to 6. FIGS. 3 and 4 show section B and section A from FIGS. 1 and 2, whilst FIGS. 5 and 6 shows section C and section D from FIGS. 1 and 2. Only one section through the support body 3a and 3b respectively is hereby shown.

The support body 3a and 3b has a plastic material matrix 10, fillers 11 which are embedded in the plastic material matrix and also reinforcing fibres 12 which are embedded in the plastic material matrix 10 and are orientated in the z direction. The support body 3b includes furthermore reinforcing fibres 13 which are orientated in the x direction. In the illustrated examples, the plastic material matrix 10 consists of an epoxy resin which is distinguished by low heat conductivity and a density of 1.1 g/cm³. The plastic material matrix 10 can likewise be manufactured from a different resin, such as for example polyester resin, phenol resin, polyurethane resin or vinyl ester resin.

The fillers 11 cause a reduction in the thermal conductivity and are configured as expanded glass granulate. The expanded glass granulate comprises foamed glass with small air-filled pores and has a diameter of approx. 1 mm to 2 mm. By the fillers 11 configured as expanded glass granulate, in addition to reducing the thermal conductivity, also a weight reduction in the floating support 1 or in the fixed support 2 is possible.

The reinforcing fibres 12 and 13 are configured as rigid glass bars which are saturated in epoxy resin and have a diameter of 2 mm and serve for increasing the pressure resistance of the fixed support 2 in the z direction or the x direction, whilst the reinforcing fibres 12 ensures an increase in pressure resistance in the z direction of the floating support 1. The bars 12 and 13 are disposed in a grid structure, however they can optionally form, also within the plastic material matrix 10, a mat, a fabric, a multiaxial fabric, a roving woven material, rovings or a woven material. The reinforcing fibres 12 extend from the lower side 8 to the upper side 7 of the support body 3a and 3b. In further embodiments, the reinforcing fibres are orientated in more than three directions. The glass bars 12 have in addition a density of 2.6 g/cm³.

For different support bodies 3a and 3b with the above-described properties, a volume proportion of the plastic material matrix, of the reinforcing fibres and of the fillers was varied and the pressure resistance and the heat conductivity of the support bodies 3a and 3b were determined. In the following table 1, the components, the pressure resistance and the heat conductivity for seven different support bodies 3a and 3b are compiled.

TABLE 1
Volume proportion of the plastic material matrix, of the reinforcing
fibres and of the fillers, pressure resistance and heat conductivity of
different support bodies i to vii.

| | Plastic material | Reinforcing | | Pressure | Heat |
|---|---|---|---|---|---|
| Support | matrix | fibres | Fillers | resistance | conductivity |
| body | [vol. %] | [vol. %] | [vol. %] | [N/mm²] | [W/mK] |
| i | 65 | 0 | 35 | 48 | 0.10 |
| ii | 60 | 15 | 25 | 72 | 0.17 |
| iii | 72 | 15 | 13 | 80 | 0.20 |
| iv | 77 | 10 | 13 | 83 | 0.21 |
| v | 95 | 0 | 5 | 120 | 0.30 |
| vi | 90 | 10 | 0 | 135 | 0.38 |
| vii | 70 | 30 | 0 | 150 | 0.50 |

It can be deduced from the table that, with an increasing quantity of fillers, the heat conductivity and the pressure resistance of the support body 3a and 3b drop. With an increasing volume proportion of reinforcing fibres, the heat conductivity and the pressure resistance of the support body 3a and 3b rise in contrast. For this reason, a compromise must be found between low heat conductivity and high pressure resistance.

It emerged that the support body 3a and 3b should have a pressure resistance in the direction of a force exerted by the liquid gas tank 5 of at least 60 N/mm² and a heat conductivity of at most 0.30 W/mK. From comparison with table 1, it emerges that the support body 3a and 3b has a filler volume proportion of at least 5% and at most 30%, advantageously 25%. The volume proportion of the reinforcing fibres 12 and 13 should be between 10% and 20%, preferably at 15%.

The support bodies 3a and 3b are, in addition, distinguished by a low density of at most 1.5 g/cm³ and a low moisture absorption of 3% at 20° C. and 65% relative air humidity. A linear heat expansion coefficient of the support bodies is 17*10⁻⁶ K⁻¹ in the longitudinal direction of the reinforcing fibres 12 and 13.

By varying the above-described properties, in particular the volume proportions of fillers, reinforcing fibres and plastic material matrix in the support body 3a and 3b, specifically reinforced or more highly insulating supports 1 and 2 can also be produced for the respective application case.

With the disclosure, a method for the production of a support 1 and 2 for mounting and thermal insulation of liquid gas tanks 5 in ships with a support body 3a and 3b which can be fixed to a structure 4 of the ship is made available.

Firstly, a mould is provided for moulding the support body 3a and 3b. Thereafter, glass fibres are saturated in an epoxy resin to form rigid glass bars 12 and 13. In the cured state of the epoxy resin, the rigid glass bars 12 and 13 which are covered with epoxy resin are orientated in the shape of a grid in the mould. In order to produce a fixed support, it can be provided that a plurality of groups of glass bars 12 and 13 are orientated in different directions. Subsequently, an expanded glass granulate is disposed in the mould around the glass bars 12 and 13. By means of a vacuum-assisted resin transfer moulding method, the mould is filled with liquid epoxy resin. After curing of the epoxy resin to form an epoxy resin matrix 10 in the mould, the finished support body 3a and 3b is removed from the mould. Subsequently, the support body 3a and 3b is mounted on the ship structure 4, after which the liquid gas tank 5 is mounted on the support body 3a and 3b. The method is suited particularly well to the production of the floating support 1 from FIG. 1 or the fixed support 2 from FIG. 2.

Features of the various embodiments disclosed in the embodiments can be combined with each other and claimed individually. Of course, the above-described material sizes can be combined with each other without leaving the scope of the disclosure.

Various modifications and additions can be made to the exemplary embodiments discussed without departing from the scope of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A support for mounting and for thermal insulation of liquid tanks in ships comprising a support body, which can be fixed to a structure of a ship and which has a plastic material matrix for reducing the thermal conductivity, fillers which are embedded in the plastic material matrix for at least one of weight reduction and reducing the thermal conductivity, and reinforcing fibres which are embedded in the plastic material matrix for increasing the pressure resistance.

2. The support according to claim 1, wherein the reinforcing fibres which are embedded in the plastic material matrix are orientated in at least one direction of a force exerted by the liquid tank on the support body.

3. The support according to claim 1, wherein the support body has a plurality of groups of reinforcing fibres which are orientated in different directions.

4. The support according to claim 1, wherein the reinforcing fibres are configured as essentially rigid bars which are covered preferably with plastic material.

5. The support according to claim 1, wherein the pressure resistance of the support body in the direction of a force exerted by the liquid tank on the support body is at least 60 N/mm².

6. The support according to claim 1, wherein the fillers are at least one of essentially spherical, have cavities, and are mixed with gases.

7. The support according to claim 1, wherein the support body has a volume proportion of the fillers of at most 35% and a volume proportion of the reinforcing fibres of at most 35%.

8. The support according to claim 1, wherein the support body has at least one of a thermal conductivity of at most 0.30 W/mK and a thermal conductivity of at least 0.10 W/mK.

9. The support according to claim 1, wherein at least one of the reinforcing fibres and the fillers have at least one of a diameter of at least 0.25 mm and a diameter of at most 5.0 mm.

10. The support according to claim 1, wherein the reinforcing fibres within the plastic material matrix form at least one of bars, a grid, a mat, a fabric, a multiaxial fabric, a roving woven material, rovings, and a woven material.

11. The support according to claim 1, wherein the support body has at least one of a specific weight of at most 1.5 g/cm³, a linear heat expansion coefficient in a temperature range of −200° C. to 100° C. of at most 20*10⁻⁶ K⁻¹, and a moisture absorption at 20° C. and 65% relative air humidity of less than 5%.

12. The support according to claim 1, wherein the reinforcing fibres are at least one of aramide-, carbon-, basalt-, glass-, polyamide-, polyester- and natural fibres.

13. The support according to claim 1, wherein the plastic material matrix comprises at least one of epoxy resin, polyester resin, phenol resin, polyurethane resin and vinyl ester resin or consists of at least one of the mentioned resins.

14. The support according to claim 1, wherein the fillers comprise at least one of hollow balls, expanded glass granulates, and foamed glass granulates.

15. A method for the production of a support for mounting and for thermal insulation of liquid tanks in ships, the support including a support body which can be fixed to a structure of the ship, the method comprising:
providing a mould;
disposing reinforcing fibres and fillers in the mould;
filling the mould with a liquid plastic material resin;
curing the plastic material resin to form a plastic material matrix; and
removing the support body from the mould.

16. The method according to claim 15, wherein filling the mould with the liquid plastic material resin is effected by at least one of a vacuum-assisted resin transfer moulding method and a vacuum injection method.

17. The method according to claim 15, wherein the reinforcing fibres are saturated in a second plastic material resin before being disposed in the mould and, in a cured state of the second plastic material resin, are orientated in the mould in at least one direction.

18. The method according to claim 15, for the production of the support according to claim 1.
